(19) United States
(12) Patent Application Publication
(10) Pub. No.: US 2007/0077482 A1
(43) Pub. Date: Apr. 5, 2007

(54) Fuel cell system and fuel storage apparatus

(75) Inventors: Kenji Kibune, Kobe-Shi (JP); Goro Fujita, Ota-Shi (JP); Takashi Yasuo, Ashikaga-shi (JP)

Correspondence Address: MCDERMOTT WILL & EMERY LLP, 600 13TH STREET, N.W., WASHINGTON, DC, 20005-3096, US

(73) Assignee: SANYO ELECTRIC CO., LTD.

(21) Appl. No.: 11/524,199

(22) Filed: Sep. 21, 2006

(30) Foreign Application Priority Data
Sep. 30, 2005 (JP) 2005-285909

(51) Int. Cl. H01M 8/04

(52) U.S. Cl. 429/34

(57) ABSTRACT

A fuel cell system includes: a fuel cell main body having a fuel cell; a fuel storage portion coupled attachably and detachably to the fuel cell main body for storing fuel to be supplied to the fuel cell; and a coupling portion which couples between the fuel cell main body and the fuel storage portion. In the system, a fuel having a concentration lower than that of a fuel stored in the fuel storage portion is allowed to flow through the coupling portion.

### BACKGROUND OF THE INVENTION

1. Field of the Invention

The present invention relates to fuel cell systems, and more particularly to a fuel cell system in which safety measures are taken for preventing a high concentration of fuel from leaking out when a cartridge type fuel tank is attached to or detached from the fuel cell system.

2. Description of the Related Art

A fuel cell, or device for generating electric energy from hydrogen and oxygen, generates electric power with high power generation efficiency. The fuel cell has the following major features. First, even a small-scale fuel cell can be expected to generate electric power with high power generation efficiency because of its direct electric power generation without following the process of thermal or kinetic energy as in conventional electric power generation schemes. In addition to low emissions of nitrogen compounds and the like, the fuel cell operates silently with reduced vibrations, and is thus more environmentally friendly. As such, since the fuel cell makes effective use of the chemical energy provided by fuel and is environmentally friendly, the fuel cell is expected to be the energy supply system of the 21st century. Thus, the fuel cell has become a focus of attention as a prospective new electric power generation system that can be employed for a wide variety of applications. These vary from large-scale to small-scale schemes, from electric power generation in space to automobiles or even for portable use. To bring the fuel cell into practical use, further technological development activities are now under way.

Among these technological developments is a solid polymer fuel cell featuring a lower operating temperature and a higher output density when compared with other types of fuel cells. In particular, attention has been recently focused on a direct methanol fuel cell (DMFC) as one form of solid polymer fuel cell. The DMFC is adapted to directly supply a methanol aqueous solution serving as a fuel to the anode without reforming it and provide electric power through an electrochemical reaction between the methanol aqueous solution and oxygen. This electrochemical reaction yields reaction products such as carbon dioxide from the anode and generated water from the cathode. The methanol aqueous solution has higher energy per unit volume and is more suitable for storage with less risk of explosion when compared with hydrogen, and is thus expected to be used as a power source in automobiles and portable devices (such as cellular phones, notebook personal computers, PDAs, MP3 players, digital cameras, or electronic dictionaries (books)).

Since electric power generation by the DMFC involves fuel consumption, a DMFC system that employs the DMFC is typically supplied with fuel from a fuel tank which is adapted to be attachable to and detachable from the DMFC system and which has pure methanol or a high concentration of methanol aqueous solution filled therein. When the fuel in the fuel tank runs out, this fuel tank is replaceable (see Japanese Patent Laid-Open Publication No. 2004-152741)

The fuel cell system allows pure methanol or methanol aqueous solution of a high concentration to flow through a coupling pipe, which couples the fuel cell main body side of the fuel cell system and the cartridge type fuel tank. Thus, measures for preventing leakage of liquid are taken at the coupling portion. However, there is a problem that when the means for preventing the leakage of liquid does not work properly, leading to leakage of liquid through the coupling portion, a high concentration of methanol is able to leak out. There is also another problem that even when the means for preventing leakage of liquid works properly, a small amount of a high concentration of methanol is volatilized and emitted through the coupling portion.

### SUMMARY OF THE INVENTION

The present invention has been developed in view of the aforementioned problems. It is an object of the present invention to provide a fuel cell system in which safety measures are taken to prevent a high concentration of methanol (fuel) from leaking out.

In order to achieve the aforementioned object, one aspect of the present invention is to provide a fuel cell system which includes a fuel cell main body having a fuel cell; a fuel storage portion coupled attachably and detachably to the fuel cell main body, the fuel storage portion storing fuel to be supplied to the fuel cell; and a coupling portion that couples the fuel cell main body and the fuel storage portion. The fuel cell system is characterized in that a fuel having a concentration lower than that of the fuel stored in the fuel storage portion is allowed to flow through the coupling portion. This arrangement prevents a high concentration of fuel from leaking out even when the fuel storage portion (or a so-called cartridge type fuel tank) is detached from the fuel cell system because only a lower concentration of fuel is present in the coupling portion (or a connector portion).

In the aforementioned aspect, the coupling portion may have a liquid exhaust substance connector through which a liquid exhaust substance emitted from the fuel cell flows from the fuel cell main body to the fuel storage portion, and a third connector through which a liquid fuel solution mixture of fuel and the liquid exhaust substance flows from the fuel storage portion to the fuel cell main body. The fuel cell emits a substance predominantly composed of a liquid containing a reduced concentration of fuel and carbon dioxide from the anode, and a substance predominantly composed of a gas containing an oxidant with a reduced concentration of oxygen and water from the cathode. Of these substances, the liquid exhaust substance is fed from the fuel cell main body to the fuel storage portion to dilute the fuel, which is in turn fed from the fuel storage portion back to the fuel cell main body, thereby allowing the reduced concentration of fuel to flow through the coupling portion.

In the aforementioned aspect, the coupling portion may have a first connector through which a gaseous exhaust substance emitted from the fuel cell flows from the fuel cell main body to the fuel storage portion, and the fuel storage portion may have a removal unit which removes an unwanted substance contained in the liquid exhaust substance and/or a deleterious substance contained in the gaseous exhaust substance. In this instance, the unwanted substance contained in the liquid exhaust substance may include substances eluted from the fuel cell, accessory devices, or pipes. For a system adapted such that air outside the fuel cell system is utilized as an oxidant and the exhaust substance from the cathode is mixed with the exhaust substance from the anode, dust particles or organic substances in the air can also be said to be an unwanted substance. On the other hand, the deleterious substance contained in the gaseous exhaust substance may include aldehyde or formic acid which is produced as an intermediate product through a reaction within the fuel cell.

In the aforementioned aspect, the removal unit may be provided to be attachable to and detachable from the fuel storage portion. This allows for replacement of the removal unit with a new one, thereby making it possible to recharge the fuel storage portion with a high concentration of fuel for reuse of the fuel storage portion.

Another aspect of the present invention is to provide a fuel storage apparatus which stores liquid fuel for use in a fuel cell. The fuel storage apparatus is characterized by including a solvent inlet portion which draws a solvent for the liquid fuel into the fuel storage apparatus, and a solution outlet portion which draws a liquid fuel solution mixture of the liquid fuel and the solvent out of the fuel storage apparatus. A fuel cell system which employs such a fuel storage apparatus prevents a high concentration of liquid fuel from leaking out even when the fuel storage apparatus is detached from the fuel cell system, because only a reduced concentration of liquid fuel, which is diluted with the solvent, is present in the coupling portion.

It should be appreciated that any appropriate combinations of the foregoing components are also intended to fall within the scope of the invention covered by a patent to be claimed by this patent application. Moreover, this summary of the invention does not necessarily describe all necessary features so that the invention may also be sub-combination of these described features.

### BRIEF DESCRIPTION OF THE DRAWINGS

FIG. 1 is a schematic block diagram illustrating the configuration of a fuel cell system according to a first embodiment; and

FIG. 2 is a schematic block diagram illustrating the configuration of a fuel cell system according to a second embodiment.

### DETAILED DESCRIPTION OF THE INVENTION

The invention will now be described by reference to the preferred embodiments. This does not intend to limit the scope of the present invention, but to exemplify the invention.

The configuration of each fuel cell system according to the embodiments will now be described in more detail with reference to the drawings. In each embodiment, a description will be made in relation to a system having a DMFC in which a methanol aqueous solution is supplied to the anode for electric power generation; however, it should be appreciated that the fuel has only to be a liquid fuel and is thus not limited to the methanol aqueous solution used in this instance.

### First Embodiment

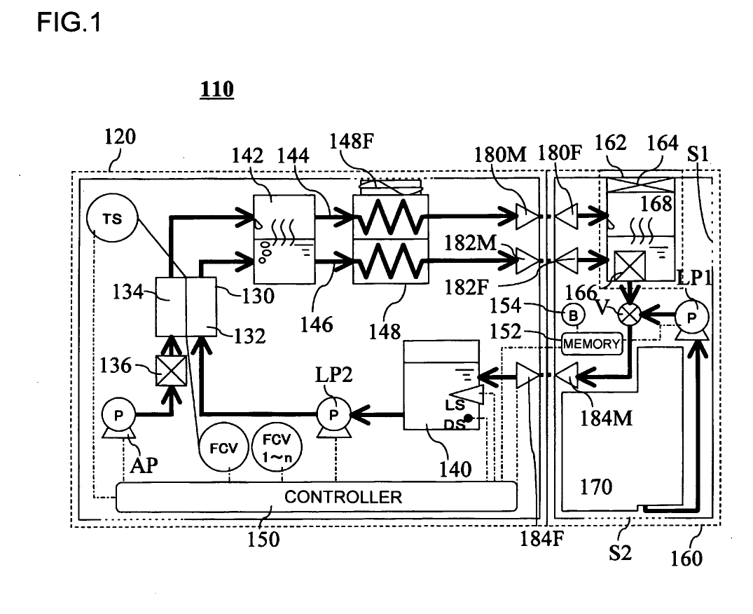

FIG. 1 is a schematic block diagram illustrating the configuration of a fuel cell system 110 according to a first embodiment of the invention. As shown in FIG. 1, the fuel cell system 110 can be largely divided into a fuel cell main body 120 and a fuel cartridge 160 in which the fuel cartridge 160 is configured to be attachable to and detachable from the fuel cell system 110.

The fuel cell main body 120 includes a fuel cell (stack) 130 which generates electric power by utilizing a methanol aqueous solution of a concentration of approximately 1 mol/L as fuel and oxygen in the air as an oxidant; a buffer tank 140 which temporarily stores the methanol aqueous solution to be supplied to the fuel cell 130; a gas-liquid separation tank 142 for allowing an anode exhaust substance emitted from an anode 132 of the fuel cell 130 and a cathode exhaust substance emitted from a cathode 134 to merge with each other and separating the exhaust substances into a gas component and a liquid component; and a radiator 148 which allows the gas component and the liquid component having been separated from the exhaust substances in the gas-liquid separation tank 142 to flow and to be cooled through a gas-phase flow pipe 144 and a liquid-phase flow pipe 146, respectively. The fuel cell main body 120 also includes a controller 150 which can control various types of pumps within the fuel cell system 110.

The fuel cartridge 160 is provided with a gas component exhaust outlet 162 from which the gas component having passed through the gas-phase flow pipe 144 of the radiator 148 is emitted out of the fuel cell system 110. The gas component exhaust outlet 162 is provided with a gas-phase filter 164 which removably adsorbs a deleterious substance such as aldehyde or formic acid in the gas component. Then, the liquid component, having passed through the liquid-phase flow pipe 146 of the radiator 148, goes through a liquid-phase filter 166 provided in the fuel cartridge 160 and passes back to the buffer tank 140 of the fuel cell main body 120. The gas-phase filter 164 and the liquid-phase filter 166 are arranged as a filter unit 168 configured to be attachable to and detachable from the fuel cartridge 160. Furthermore, a fuel bag 170 having a high concentration of methanol of 20 mol/L or more filled therein is formed of a pliant or flexible material to fill in a cavity within the fuel cartridge 160 as much as possible. The high concentration of methanol drawn from the bottom portion of the fuel bag 170 goes through a liquid pump LP1 to merge at a three-way valve V with the methanol aqueous solution having passed through the liquid-phase filter 166, and is then added to the buffer tank 140 of the fuel cell main body 120.

That is, the fuel cell main body 120 and the fuel cartridge 160 are coupled to each other via a first connector 180, a second connector 182, and a third connector 184. The first connector (gaseous exhaust substance connector) 180 primarily allows the gas component of the exhaust substance emitted from the fuel cell 130 to flow therethrough from the fuel cell main body 120 towards the fuel cartridge 160. The second connector (liquid exhaust substance connector) 182 primarily allows the liquid component of the exhaust substance emitted from the fuel cell 130 to flow therethrough from the fuel cell main body 120 towards the fuel cartridge 160. The third connector (liquid fuel solution connector) 184 primarily allows the liquid component of the exhaust substance emitted from the fuel cell 130 to flow therethrough from the fuel cartridge 160 towards the fuel cell main body 120. When the concentration of the methanol in the buffer tank 140 is lower than a predetermined threshold value, the third connector 184 also allows a high concentration of methanol from the fuel bag 170 to merge with the liquid component and flow therethrough. Although not illustrated, the connectors 180, 182, and 184 are arranged asymmetrically to avoid confusion between the positions of their joints, and the direction of fluid flowing therethrough is also taken into account. Accordingly, the first connector 180 and the second connector 182 are male on the fuel cell main body 120 side and female on the fuel cartridge 160 side, while the third connector 184 is female on the fuel cell main body 120 side and male on the fuel cartridge 160 side.

The buffer tank 140 is provided with a concentration sensor DS for sensing the concentration of the methanol aqueous solution therein, as described above. The controller 150 allows the concentration sensor DS to monitor the concentration of the fuel to be supplied to the fuel cell 130. In addition to this, the controller 150 also provides control to each of various types of accessory devices such as the liquid pumps LP1 and LP2, an air pump AP, the three-way valve V, and a fan 148F in accordance with the total amount of the methanol aqueous solution (using a liquid level sensor LS), the temperature of the fuel cell (using a temperature sensor TS), the state of electric power generation by the fuel cell (using voltmeters FCV (using total voltage values) and FCVn (using block voltage values)) as well as information regarding the high concentration of methanol (its date of manufacture, ID, concentration, and volume) from a memory 152 provided in the fuel cartridge 160. Furthermore, the third connector 184F of the fuel cell main body 120 is provided with a limiter (not shown) which is adapted to sense whether the fuel cartridge 160 is properly attached to, or detached from, the fuel cell system 110.

The fuel cell system 110 configured in this manner does not allow a high concentration of fuel (methanol) to flow through the pipes of the coupling portions between the fuel cell main body 120 and the fuel cartridge 160 (the first connector 180, the second connector 182, and the third connector 184), and thus prevents the high concentration of fuel from leaking out when the fuel cartridge 160 is attached to, or detached from, the fuel cell system 110. Additionally, the filter unit 168 is also adapted to be attachable to and detachable from the fuel cartridge 160, and the fuel cartridge 160 further includes the memory 152. Thus, this arrangement allows for refilling of the fuel bag 170 with a high concentration of fuel and replacement of the filter unit 168 with a new one at the time of replacement (calculated by the memory 152) of the gas-phase filter 164 or the liquid-phase filter 166, thereby making it possible to reuse the fuel cartridge 160.

### Second Embodiment

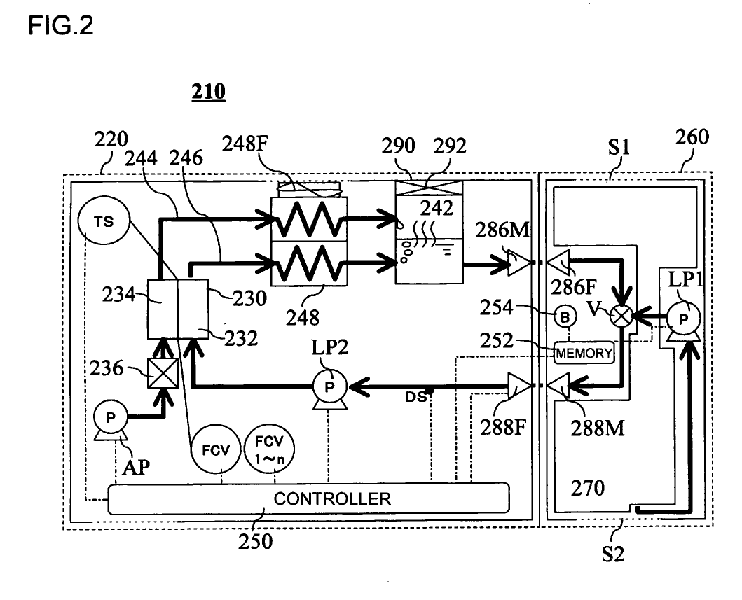

FIG. 2 is a schematic block diagram illustrating the configuration of a fuel cell system 210 according to a second embodiment of the invention. As shown in FIG. 2, like the first embodiment, the fuel cell system 210 can also be largely divided into a fuel cell main body 220 and a fuel cartridge 260, in which the fuel cartridge 260 is adapted to be attachable to and detachable from the fuel cell system 210.

The fuel cell main body 220 is configured to include: a fuel cell (stack) 230 which generates electric power by utilizing a methanol aqueous solution of a concentration of approximately 1 mol/L as fuel and oxygen in the air as an oxidant; a radiator 248 which allows an anode exhaust substance emitted from an anode 232 of the fuel cell 230 and a cathode exhaust substance emitted from a cathode 234 of the fuel cell 230 to flow and to be cooled through an anode exhaust pipe 246 and a cathode exhaust pipe 244, respectively; and a gas-liquid separation tank 242 which allows the anode exhaust substance and the cathode exhaust substance to merge with each other and separates the exhaust substances into a gas component and a liquid component. The gas-liquid separation tank 242 is provided with a gas component exhaust outlet 290 through which the gas component is emitted out of the fuel cell system 210. The gas component exhaust outlet 290 is provided with a gas-phase filter 292 which removably adsorbs a deleterious substance such as aldehyde or formic acid in the gas component. The fuel cell main body 220 is also provided with a controller 250 which can control various types of pumps within the fuel cell system 210.

On the other hand, the fuel cartridge 260 is configured to include a fuel bag 270 which has a high concentration of methanol of 20 mol/L or more filled therein and is formed of a pliant or flexible material to fill in a cavity within a fuel cartridge 260 as much as possible. The liquid component, having been separated at the gas-liquid separation tank 242 of the fuel cell main body 220, goes through the three-way valve V provided on the fuel cartridge 260 and passes back to the fuel cell main body 220. The high concentration of methanol drawn from the bottom portion of the fuel bag 270 goes through the liquid pump LP1 to merge at the three-way valve V with the liquid component (the methanol aqueous solution) having been separated at the gas-liquid separation tank 242, thereby adjusting the concentration of the methanol aqueous solution to be supplied to the fuel cell 230.

That is, the fuel cell main body 220 and the fuel cartridge 260 are coupled to each other via a forward path connector 286 and a return path connector 288. The forward path connector 286 allows the liquid component of the exhaust substance emitted from the fuel cell 230 to flow therethrough from the fuel cell main body 220 towards the fuel cartridge 260. The return path connector 288 allows the liquid component of the exhaust substance emitted from the fuel cell 230 to flow therethrough from the fuel cartridge 260 towards the fuel cell main body 220. When the concentration of the methanol aqueous solution to be supplied to the fuel cell 230 is lower than a predetermined threshold value, the return path connector 288 also allows a high concentration of methanol from the fuel bag 270 to merge with the liquid component and flow therethrough. Although not illustrated, the connectors 286 and 288 are arranged asymmetrically to avoid confusion between the positions of their joints, and the direction of fluid flowing therethrough is also taken into account. Accordingly, the forward path connector 286 is male on the fuel cell main body 220 side and female on the fuel cartridge 260 side, while the return path connector 288 is female on the fuel cell main body 220 side and male on the fuel cartridge 260 side.

To sense the concentration of the methanol aqueous solution to be supplied to the fuel cell 230 as described above, the concentration sensor DS is provided between the three-way valve V and the fuel cell 230. The controller 250 allows the concentration sensor DS to monitor the concentration of the fuel to be supplied to the fuel cell 230. In addition to this, the controller 250 also provides control to each of various types of accessory devices such as the liquid pumps LP1 and LP2, an air pump AP, the three-way valve V, and a fan 248F in accordance with the temperature of the fuel cell (using a temperature sensor TS), the state of electric power generation by the fuel cell (using voltmeters FCV (using total voltage values) and FCVn (using block voltage values)) as well as information regarding the high concentration of methanol (its date of manufacture, ID, concentration, and volume) from a memory 252 provided on the fuel cartridge 260. Furthermore, the return path connector 288F of the fuel cell main body 220 is provided with a limiter (not shown), which is adapted to sense whether the fuel cartridge 260 is properly attached to or detached from the fuel cell system 210.

The fuel cell system 210 configured in this manner does not allow a high concentration of fuel (methanol) to flow through the pipes of the coupling portions between the fuel cell main body 220 and the fuel cartridge 260 (the forward path connector 286 and the return path connector 288), and thus prevents the high concentration of fuel from leaking out when the fuel cartridge 260 is attached to or detached from the fuel cell system 210.

In addition to this, not only the housing of the fuel cell main bodies 120 and 220, but also the housing of the fuel cartridges 160 and 260 can be provided with slits S1 and S2, thereby allowing outside air to flow through the fuel cartridges 160 and 260 and cool the inside of the fuel cartridges 160 and 260. In particular, the fuel cell systems 110 and 210 allow the exhaust substance from the fuel cells 130 and 230 to flow through the fuel cartridges 160 and 260. Thus, the slits S1 and S2 provided in the fuel cartridges 160 and 260 to cool the exhaust substance in the fuel cartridges 160 and 260 could effectively reduce the size of the radiators 148 and 248 of the fuel cell main bodies 120 and 220. Furthermore, although the fuel bags 170 and 270 were described to fill in a cavity in the fuel cartridges 160 and 260 as much as possible, the filter unit 168 (the first embodiment) and the pipe from the forward path connector 286F to the three-way valve V (the second embodiment), which produce remarkable effects of cooling, may be arranged so that air flows between the slit S1 and the slit S2.

It is contemplated that the present invention can be utilized for a fuel cell system which employs a liquid fuel that is expected to be used for various devices, and in particular, portable devices.

What is claimed is:

1. A fuel cell system comprising:
a fuel cell main body having a fuel cell;
a fuel storage portion coupled attachably and detachably to the fuel cell main body, the fuel storage portion storing fuel to be supplied to the fuel cell; and
a coupling portion which couples the fuel cell main body and the fuel storage portion, wherein
a fuel having a concentration lower than that of the fuel stored in the fuel storage portion is allowed to flow through the coupling portion.

2. The fuel cell system according to claim 1, wherein
the fuel storage portion has a merging portion which allows the fuel supplied from the fuel storage portion and a liquid exhaust substance emitted from the fuel cell to merge with each other in order to control a concentration of the fuel.

3. The fuel cell system according to claim 1, wherein
the coupling portion has a gaseous exhaust substance connector through which a gaseous exhaust substance emitted from the fuel cell flows from the fuel cell main body to the fuel storage portion, and
the fuel storage portion has a removal unit which removes a deleterious substance contained in the gaseous exhaust substance.

4. The fuel cell system according to claim 1, wherein
the coupling portion has a liquid exhaust substance connector through which a liquid exhaust substance emitted from the fuel cell flows from the fuel cell main body to the fuel storage portion, and a liquid fuel solution connector through which a liquid fuel solution mixture of fuel and the liquid exhaust substance flows from the fuel storage portion to the fuel cell main body.

5. The fuel cell system according to claim 4, wherein
the coupling portion has a gaseous exhaust substance connector through which a gaseous exhaust substance emitted from the fuel cell flows from the fuel cell main body to the fuel storage portion, and
the fuel storage portion has a removal unit which removes an unwanted substance contained in the liquid exhaust substance and/or a deleterious substance contained in the gaseous exhaust substance.

6. The fuel cell system according to claim 3, wherein
the removal unit is provided to be attachable to and detachable from the fuel storage portion.

7. The fuel cell system according to claim 5, wherein
the removal unit is provided to be attachable to and detachable from the fuel storage portion.

8. A fuel storage apparatus which stores liquid fuel for use in a fuel cell, comprising:
a solvent inlet portion which draws a solvent for the liquid fuel into the fuel storage apparatus; and
a solution outlet portion which draws a liquid fuel solution mixture of the liquid fuel and the solvent out of the fuel storage apparatus.
